(19) United States
(12) Patent Application Publication
(10) Pub. No.: US 2012/0265558 A1
(43) Pub. Date: Oct. 18, 2012

(54) UNEMPLOYMENT INDICATOR PREDICTION

(75) Inventors: MATHEW F. MENZ, YORK, SC (US); ALLAN S. VOLTZ, BROWNS SUMMIT, NC (US)

(73) Assignee: BANK OF AMERICA CORPORATION, CHARLOTTE, NC (US)

(21) Appl. No.: 13/088,013

(22) Filed: Apr. 15, 2011

(51) Int. Cl. G06Q 40/00; G06Q 10/00

(52) U.S. Cl. 705/4; 705/7.29

(57) ABSTRACT

A method for determining unemployment insurance payment dollars and/or the unemployment rate at some point in the future includes receiving various data and performing a calculation based on such received data. In one embodiment, the unemployment insurance payment dollars can be determined in two quarters in the future by receiving data of percent change in personal consumption expenditures, receiving data of change in non-residential investment, and receiving data of median rent, and then, calculating such future total unemployment insurance payment dollars based on the percent change in personal consumption expenditures data, the change in non-residential investment data, and the median rent data.

### BACKGROUND OF INVENTION

Because of the past uncertain economic years and the likelihood for such uncertainty to continue in the unforeseeable future, mortgagors and other debtors may be interested in protection or cancellation of debt in the event of some unforeseen occurrence. Examples of such unforeseen occurrences may include disability of the borrower or mortgagor, involuntary unemployment, bankruptcy, accidental death or the like. By knowing the likelihood of these events in the future, financial institutions would be able to better offer products or protect current investments. To do this, financial institutions would need to somehow predict indicators that would affect product performance.

### SUMMARY

Financial institutions (or other entities) desire to know what the unemployment insurance payment dollars or the unemployment rate will be in the future. By knowing what these indicators will be a predetermined time in the future, financial institutions could plan accordingly, such as making sure homeowners are not foreclosed on due to involuntary unemployment (and therefore a lowering of income). Embodiments of the present invention allow a financial institution to predict with a high certainty the unemployment insurance payment dollars or unemployment rate a certain period of time (3 months, 6 months, 9 months, etc.) in the future and to plan their products accordingly.

In accordance with an embodiment of the present invention, a method includes determining unemployment insurance payment dollars in two quarters in the future by receiving data of change in personal inventories, receiving data of percent change in non-residential investment, receiving data of median rent, and determining a total unemployment insurance payment dollars at a future predetermined date based thereon. In one embodiment, this determination is performed by using the following formula:

TOTAL NATIONAL UNEMPLOYMENT PAYMENT DOLLARS=−2,607,265.95+(−34,646,777.27X % CHANGE IN NON-RESIDENTIAL INVESTMENT)+(−24,516.205X CHANGE IN PRIVATE INVENTORIES)+(21,976.84X MEDIAN RENT)

In accordance with another embodiment of the present invention, a method includes determining unemployment insurance payment dollars in two quarters in the future by receiving data of change in personal consumption expenditures; receiving data of change in private inventories; receiving data of median rent; and determining a total unemployment insurance payment dollars at a future predetermined date based thereon. In one embodiment, this determination is performed by using the following formula:

TOTAL NATIONAL UNEMPLOYMENT PAYMENT DOLLARS=293,414.42+(−141,668,643.19X % CHANGE PERSONAL EXPENDITURES)+(19,427.36X MEDIAN RENT)+(−26,130.72X CHANGE PRIVATE INVENTORIES)

In accordance with another embodiment of the present invention, a method includes determining unemployment rate in six months in the future by receiving Dow Jones index data; receiving Chicago Board Data Exchange Volatility Index (VIX) data; and determining a unemployment rate at a future predetermined date based on the Dow Jones index data and the Chicago Board Data Exchange Volatility Index (VIX) data. This determination, according to an embodiment is performed by using the following formula:

UNEMPLOYMENT RATE=13.752+(−0.0007716X DOW JONES)+(0.07656X VIX)

In accordance with another embodiment of the present invention, a system includes a hardware processor and a module operable on the hardware processor. The module is configured for receiving data of change in personal consumption expenditures; receiving data of median rent; and determining a total unemployment insurance payment dollars at a future predetermined date based on the change in personal consumption expenditures data and the median rent data.

The features, functions, and advantages that have been discussed may be achieved independently in various embodiments of the present invention or may be combined with yet other embodiments, further details of which can be seen with reference to the following description and drawings.

### BRIEF DESCRIPTION OF DRAWINGS

FIG. 1 is a flow chart of a method for an unemployment data prediction in accordance with some embodiments of the present invention.

FIGS. 2A-C are flow charts of methods for unemployment data prediction in accordance with some embodiments of the present invention.

FIGS. 3-4 illustrates charts useable with FIGS. 2A-2C and FIG. 3.

FIG. 5 is a flow chart illustrating borrower's protection plan according to one embodiment.

FIG. 6 is a flow chart illustrating borrower's protection plan according to another embodiment.

FIG. 7 is a block schematic diagram of an example of a system for a borrower's protection plan in accordance with an embodiment.

FIG. 8 is a flow chart illustrating borrower's protection plan using the predictive models according to some embodiments of the present invention.

FIG. 9 is a block schematic diagram of an example of a system for a borrower's protection plan and the present predictive methodology in accordance with an embodiment.

### DETAILED DESCRIPTION

Embodiments of the present invention will now be described more fully hereinafter with reference to the accompanying drawings, in which some, but not all, embodiments of the invention are shown.

Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like.

Embodiments of the present invention provide a system and method for predicting financial indicators, such as predicting the unemployment loss payment dollars. Embodiments of the invention allow a financial institution to predict in the future how many dollars will be lost to unemployment insurance. This information can be used by the financial institution to manage/offer various products, such as Borrower's Protection Plan (“BPP”). This allows for financial institutions to avoid potential losses in the future based on the knowledge of the future indicator, unemployment insurance loss payment dollars.

The present application is organized into four sections: (1) Model for Predicting Unemployment Insurance Payment Dollars; (2) Model for Predicting Unemployment Rate; (3) Borrower's Protection Plan; and (4) Borrower's Protection Plan as Using the Model for Predicting Unemployment Insurance Payment Dollars and Module for Predicting Unemployment Rate.

Model for Predicting Unemployment Insurance Payment Dollars

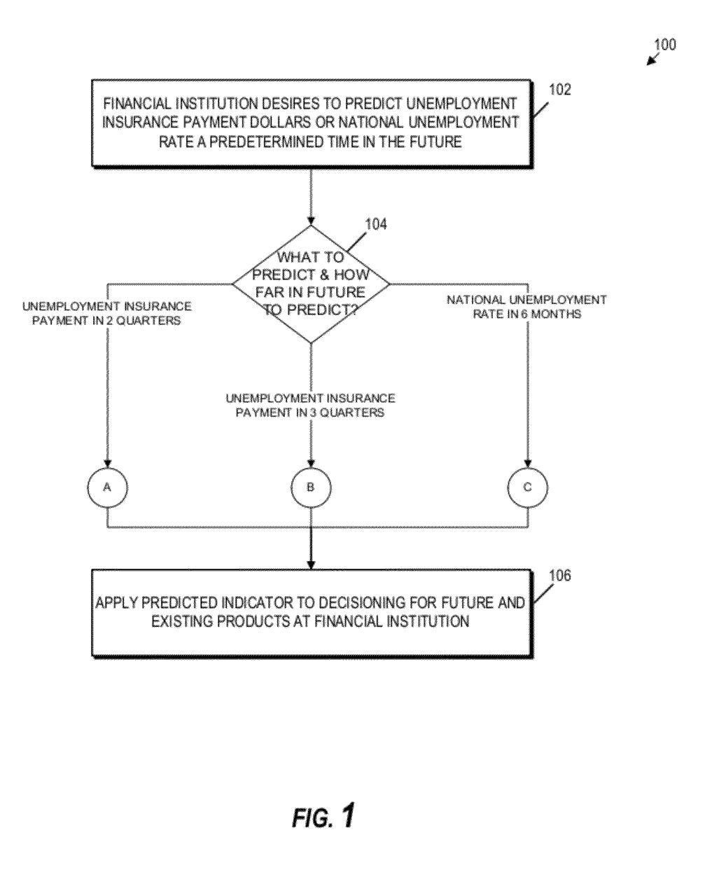

FIG. 1 illustrates a flow chart of some embodiments of the present invention directed to a method 100 of predicting unemployment insurance payment dollars and performing an action using the same. It should be noted that, in some embodiments, unemployment insurance payment dollars rates to money that is paid as a direct result of unemployment (e.g., involuntary unemployment) which would trigger coverage by unemployment insurance. Such dollars is directly may be related to the future unemployment rate and thus a valuable piece of information.

In block 102, a financial institution (or other entity) desires to predict unemployment insurance payment dollars a predetermined time in the future. The time in the future can be any time. In some embodiments, the time can be two quarters of a year, three quarters of a year, etc. Therefore, in block 104, a determination is made as to how far in the future the financial institution wants to predict the unemployment insurance payment dollars.

As shown in FIG. 1, if the financial institution desires to predict the unemployment insurance payment dollars approximately 2 quarters in the future, the method 100 continues to reference A, which continues at FIG. 1A, described later. If the financial institution desires to predict the unemployment insurance payment dollars approximately 3 quarters in the future, the method 100 continues to reference B, which continues at FIG. 1B, described later. Additionally, if the financial institution desires to predict the unemployment insurance payment dollars approximately 6 months in the future, the method 100 continues to reference C, which continues at FIG. 1C, described later. In each of these figures, it will be described (according to some embodiments) how the unemployment insurance payment dollars are predicted.

Nonetheless, after the method predicts the unemployment insurance payment dollars, the financial institution may use such information to the financial institution's benefit. One example is using the unemployment insurance payment dollars predicted value with a product called Borrower's Protection Plan (“BPP”), which is discussed later.

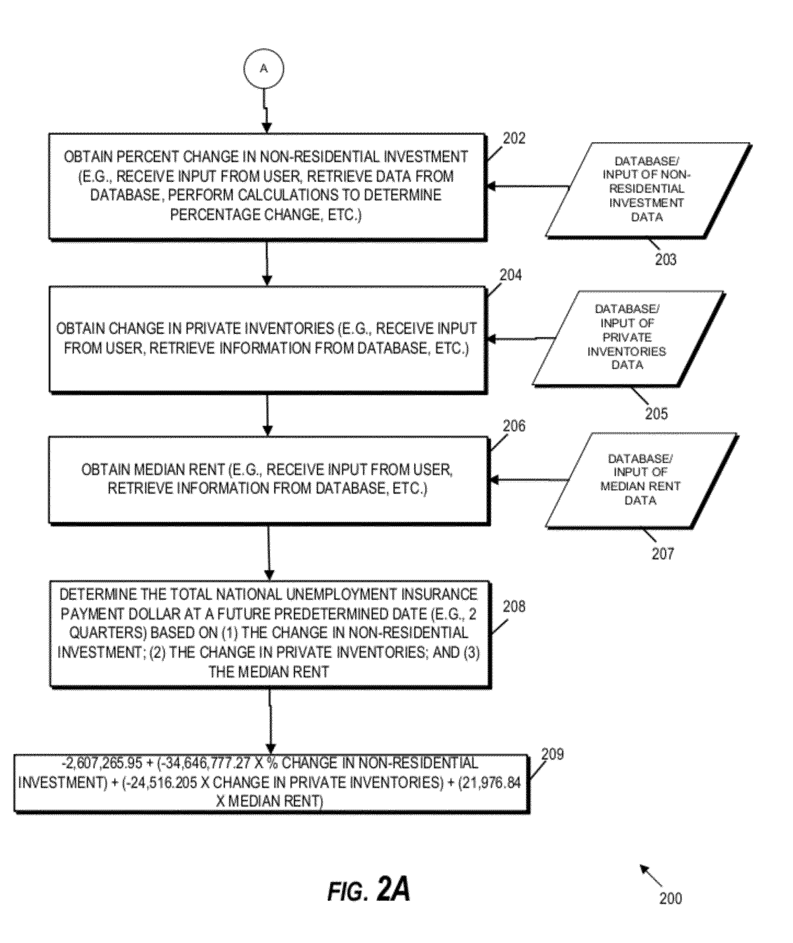

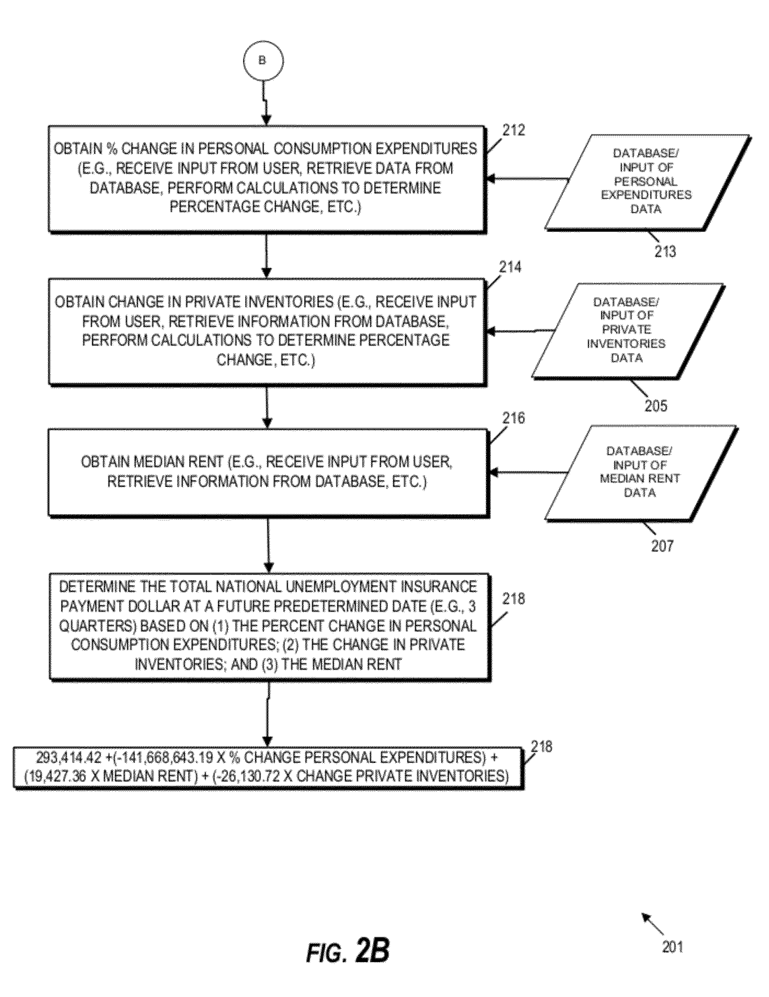

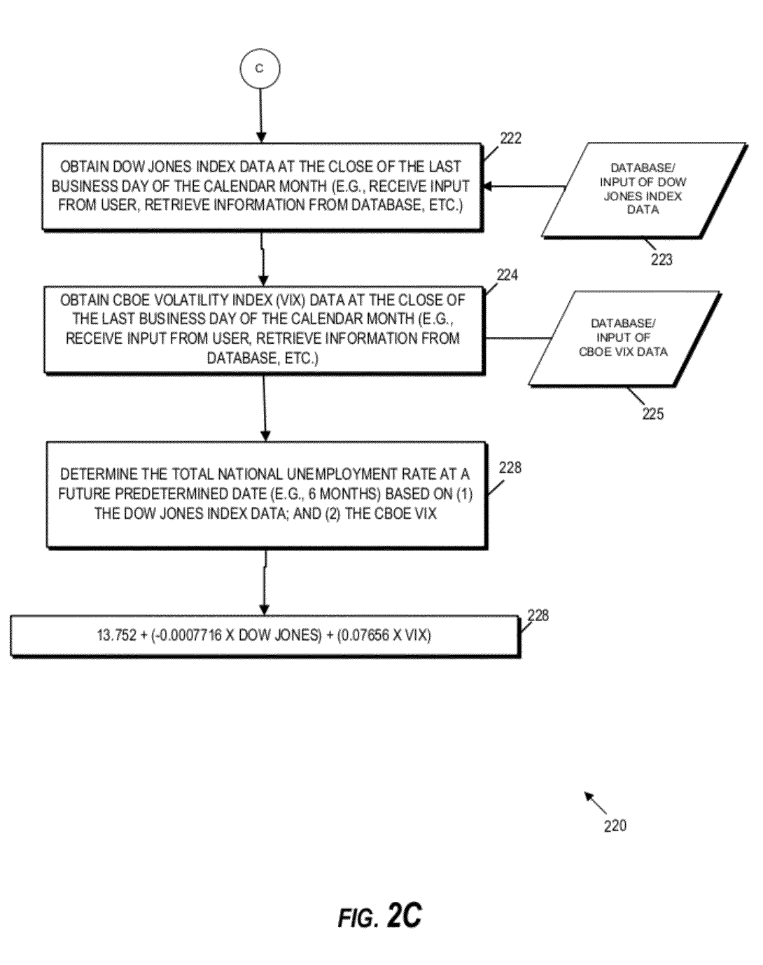

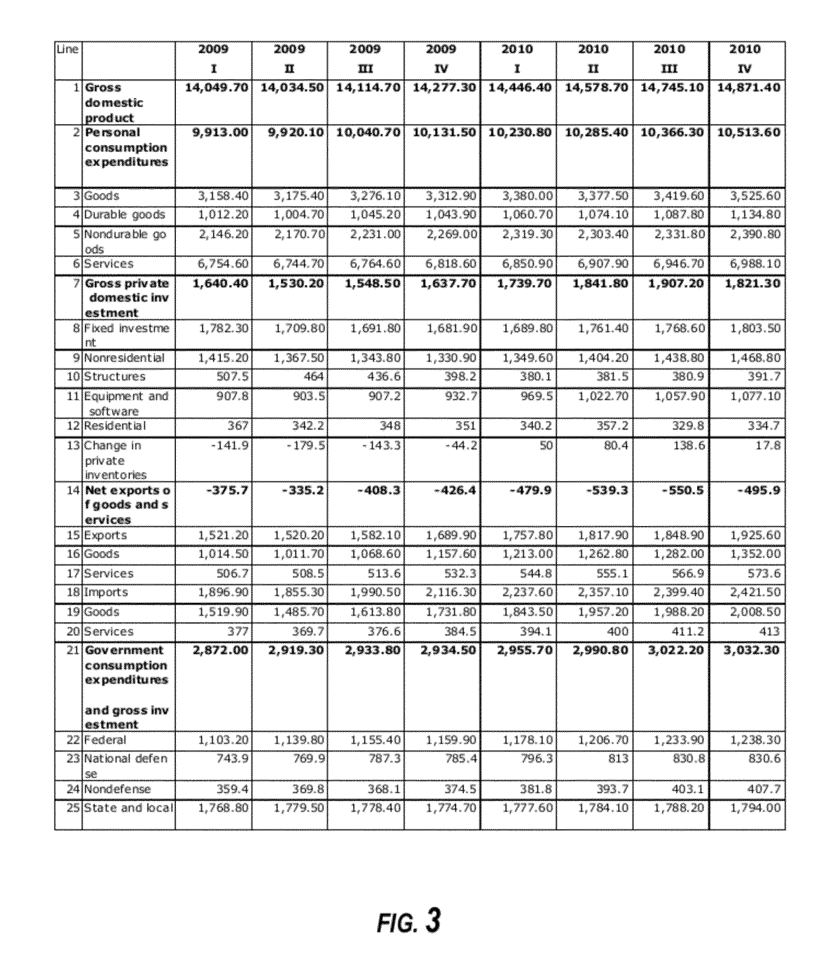

Referring now to FIG. 2A, in blocks 202-207, various information is obtained. For example, in block 202, change in non-residential investment are obtained. This data could be inputted by a user or the data could be retrieved from a database 203. This data may be published in Table 1.1.5, Line #9 at http://www.bea.gov/national/nipaweb/SelectTable.asp?Popular=Y. This table is reproduced at FIG. 3. As illustrated at line 9, the non-residential investment data is shown for the first quarter of 2009 through the fourth quarter of 2010. It should be noted that database 203 could be at a server hosting such website.

In block 204, change in private inventories are obtained. This data could be also inputted by a user or the change in private inventories data could be retrieved from a database 205. This data may be published in Table 1.1.5, Line #13 at http://www.bea.gov/national/nipaweb/SelectTable.asp?Popular=Y. As previously mentioned, this table is produced in FIG. 3.

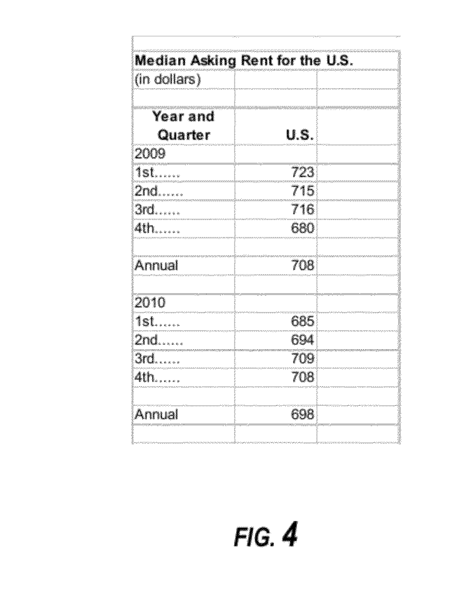

In block 206, the median rent data is obtained. This median rent data could be inputted by a user or could be retrieved from a median rent database 207. This data could be retrieved from a database hosting Table 11A, Column B at: http://www.census.gov/hhes/www/housing/hvs/historic/index.html. This table is reproduced at FIG. 4 for years 2009 and 2010.

It should be noted that the change in non-residential investment data and the change in private inventories data could be calculated using the absolute private inventories values and absolute non-residential investment data. In one embodiment, the percent change in non-residential investment is determined by taking the absolute value of in non-residential investment from the previous quarter and determining the percent different with the quarter of interest. For example, if the first quarter of 2010 has a non-residential investment value of 110 and the previous quarter (i.e., the fourth quarter of 2009) has a non-residential investment value of 100, the change in non-residential investment data for the first quarter of 2010 is 10%.

Regardless, after the data is collected in blocks 202-206, in block 208, the total national unemployment insurance payment dollars is determined at a future predetermined data (e.g., 2 quarters) in the future based on the percent change in non-residential investment, change in private inventories, and median rent.

In block 209, according to some embodiments, the total national unemployment insurance payment dollars is determined by using the following formula, which uses a combination of the obtained percent change in non-residential investment, obtained change in private inventories, and obtained median rent:

TOTAL NATIONAL UNEMPLOYMENT PAYMENT DOLLARS=−2,607,265.95+(−34,646,777.27X % CHANGE IN NON-RESIDENTIAL INVESTMENT)+(−24,516.205X CHANGE IN PRIVATE INVENTORIES)+(21,976.84X MEDIAN RENT)

This provides a financial institution the total national unemployment payment dollars two quarters in the future. In other embodiments, the total national unemployment payment dollars can be determined three quarters in the future, as is discussed below with regard to FIG. 2B. It should be noted that the current and past total national unemployment payment dollars data can be found at http://www.ows.doleta.gov/unemploy/claimssum.asp (and then clicking “U.S. total” and selecting the particular date). This is the data that embodiments of the present application can predict

Referring now to FIG. 2B, this method 201 predicts the total national unemployment payment dollars three quarters in the future. In block 212, percent change in personal consumption expenditures data is obtained calculated. This is done by obtaining data containing the current quarter data point of personal consumption expenditures and then calculating the percentage change in that data point from the previous published quarter. This data could be inputted by a user or the data could be retrieved from a database 213. This data may be published in Table 1.1.5, Line #2 at http://www.bea.gov/national/nipaweb/SelectTable.asp?Popular=Y. As previously mentioned, this table is produced in FIG. 3.

In block 214, change in private inventories data is obtained. This data could be also inputted by a user or the change in private inventories data could be retrieved from a database 205. This data may be published in Table 1.1.5, Line #13 at http://www.bea.gov/national/nipaweb/SelectTable.asp?Popular=Y. As previously mentioned, this table is produced in FIG. 3.

In block 216, median rent data is obtained. This median rent data could be inputted by a user or could be retrieved from a median rent database 207. As mentioned above with regard to FIG. 2A, this median rent data could be retrieved from a database hosting Table 11A, Column B at: http://www.census.gov/hhs/www/housing/hvs/historic/index.html. This table is reproduced at FIG. 4 for years 2009 and 2010.

After the above-identified data is collected in blocks 212-216, in block 218, the total national unemployment insurance payment dollars is determined at a future predetermined data (e.g., 3 quarters) in the future based on the percent change in personal consumption expenditures, change in private inventories, and median rent.

In block 219, according to some embodiments, the total national unemployment insurance payment dollars is determined by using the following formula, which uses a combination of the obtained percent change in personal expenditures, obtained change in private inventories, and obtained median rent:

TOTAL NATIONAL UNEMPLOYMENT PAYMENT DOLLARS=293,414.42+(−141,668,643.19X % CHANGE IN PERSONAL EXPENDITURES)+(19,427.36X MEDIAN RENT)+(−26,130.72X CHANGE PRIVATE INVENTORIES)

This provides a financial institution the total national unemployment payment dollars three quarters in the future. In other embodiments, the total national unemployment payment dollars can be determined three quarters in the future, as is discussed below with regard to FIG. 2B.

Model for Predicting National Unemployment Rate

FIG. 2C illustrates a method 220 for determining the unemployment rate. In blocks 222-225, data is collected, including the Dow Jones Index data (block 222) and the CBOE Volatility Index (VIX) data (block 224), both at the close of the last business day of the calendar month. Such data can be collected from a database (or input by a user) via blocks 223 and 225, respectively. After the Dow Jones and VIX data is collected, the national unemployment rate is predicted 6 months in the future, using the following formula:

UNEMPLOYMENT RATE=13.752+(−0.0007716X DOW JONES)+(0.07656X VIX)

where the “DOW JONES” is the obtained Dow Jones data and the “VIX” is the obtained CBOE Volatility Index data.

This data can then be used in products, such as BPP, which is discussed below.

Borrower's Protection Plan

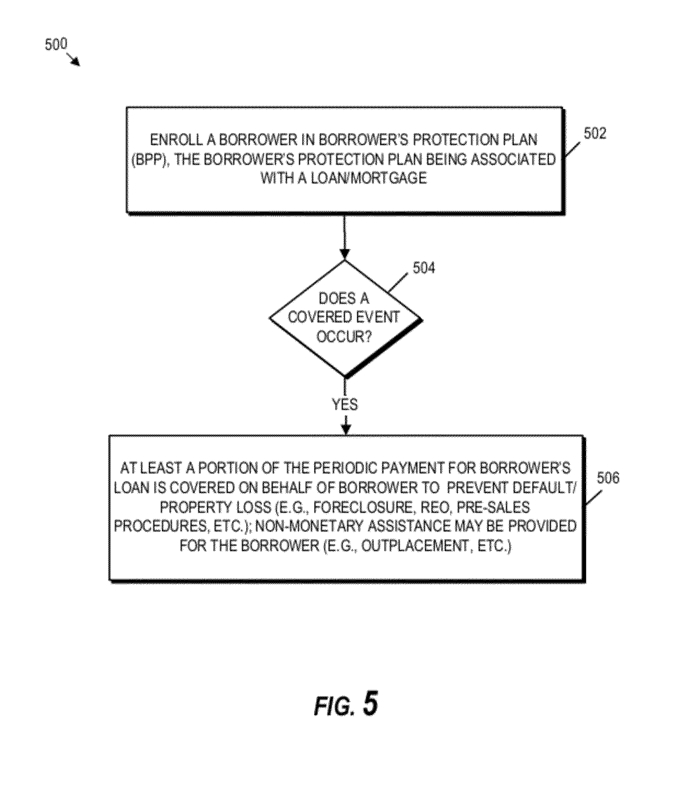

FIG. 5 is a high-level method 100 of a BPP in accordance with an embodiment of the present invention. As illustrated in block 502, a borrower is enrolled in BPP, where BPP is associated with a loan that may be secured by property, according to some embodiments of the present invention. As represented by decision block 104, a determination is made as to whether a covered event occurs. As represented by block 506, if a covered event occurs, at least a portion of the periodic payment on the borrower's loan is covered (i.e., paid, postponed, waived, or canceled) by another entity on the borrower's behalf as long as the BPP plan is active for the borrower, thereby effectively preventing foreclosure, default or other property loss for the borrower for a period of time (even though the borrower is not paying the complete periodic payment during such time). Additionally, for those who became involuntarily unemployed, non-monetary assistance may be provided to the borrower, including outplacement assistance (e.g., providing office space, maintaining a job bank, allowing access to a career search tool, providing career consulting and resume writing assistance, providing a dedicated career coach, etc.).

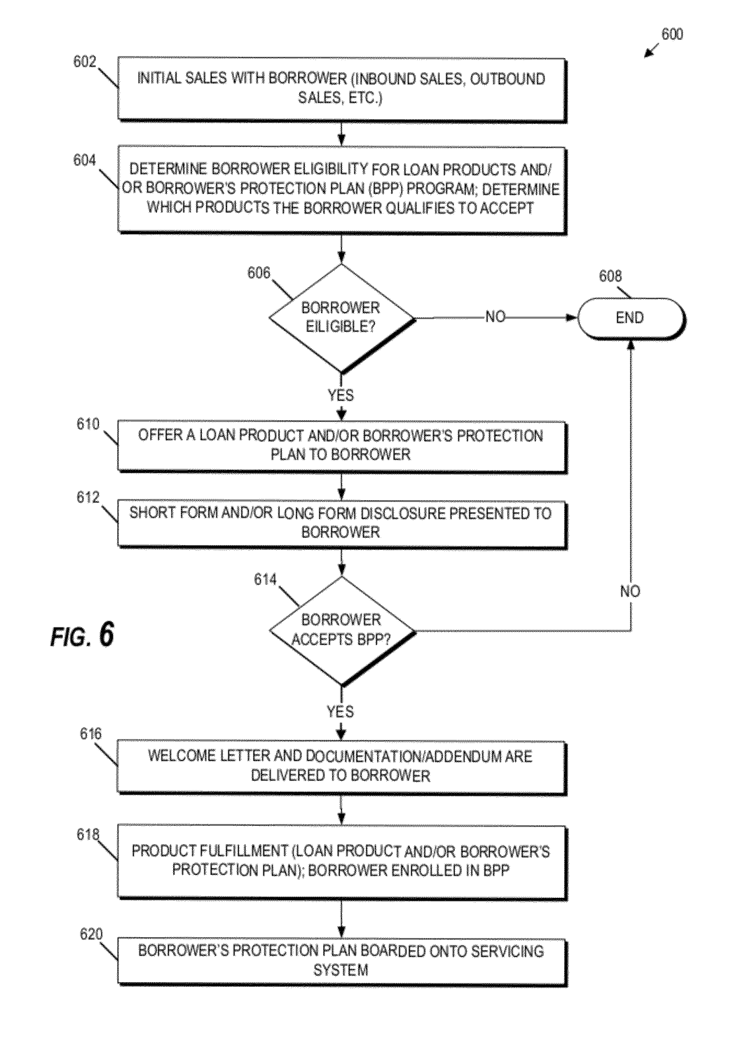

FIG. 6 is a flow chart of a method 600 for a front-end portion of a BPP plan in accordance with an embodiment of the present invention. In block 602, a sales system engages a potential borrower to present the various products of the financial institution to enroll a potential borrower in the BPP plan. In presenting these products, a borrower meets with a representative of a lending institution, such as a bank, credit union or other financial institution. Alternatively, the borrower is presented with the products via an online banking system. Regardless, the potential sale may be an inbound sale or an outbound sale in order to make initial contact with the borrower.

After the sales system engages the potential borrower, the eligibility of the borrower obtaining a secured loan and/or borrower's protection is determined, as shown in block 604. The lender inputs or enters selected information related to the borrower into a web form or the like presented on a web page or other software program. The web form may be created using Java, HTML or other web-based language. The selected information related to the borrower may include basic demographic information, such as age, sex, resident address, credit history and the like. The selected loan information includes amount being borrowed, security or collateral, term of the loan, interest rate and similar information.

Continuing with block 304, after determining borrower eligibility, a determination is made as to which products the borrower qualifies to accept. The financial institution representative selects an appropriate loan product (e.g., mortgage) and/or the borrower's protection plan based upon the borrower's circumstances and the purpose for the products. One or more loan products that the borrower qualifies for may be offered to the borrower.

If decision block 606 determines that the borrower is not eligible, the method 600 continues to block 608 where the method 600 ends. Otherwise, the method 600 continues to block 610.

The financial institution representative sells one or more of the qualified loan products to the borrower by first offering a loan product to the borrower, as shown in block 610. In addition to or in lieu of offering the loan product to the borrower, the financial institution representative provides information and advises the borrower about the borrower's protection plan. For example, the financial representative can offer the BPP plan along with a loan that is being offered to the borrower as an addendum to the just-offered loan. By way of another example, if the borrower is already obligated under an existing loan, the financial institution representative may offer the BPP plan to the borrower as an addendum to such existing loan to help prevent default on the existing loan and/or to prevent any property that is secured to the existing loan. The financial institution representative also accesses a web site of a BPP servicer for information about the product and for a quote for the product based on information related to the borrower and the loan. In block 612, the information provided to the borrower includes a short form disclosure and/or long form disclosure related to the loan and/or BPP plan as may be required by law. Other information and disclosures may also be presented to the borrower.

In one embodiment, the BPP may be non-optional for the borrower that is trying to obtain a loan, such that the BPP must be included as required part of a loan. Additionally, the BPP may be non-optional for borrowers who already have existing loans, but who meet certain predefined criteria.

It is noted that the BPP plan may be offered to the borrower for free or a reduced fee for a predetermined amount of time. In one embodiment, the BPP plan is offered for free for twelve months, for example, where no fees are incurred or collected during this time for the BPP plan to remain active. After the predetermined amount of time, periodic fees may be collected for the BPP plan to remain active so that, in the event that a covered event occurs, BPP will cover the loan payments for the borrower. The periodic fees may be a premium paid for the BPP plan. It is noted that the periodic fees collected may be in addition to any principal and interest (P&I) payments made on the loan or may be taken directly out of each P&I payment made by the borrower, such as by taking a portion of the interest payment and applying that interest portion as the fee for the BPP plan to remain active.

Nonetheless, in decision block 614, a determination is made as to whether the borrower accepts BPP. The borrower can accept BPP by signing the required documents, such as an BPP agreement, loan BPP addendum, and/or the like. Depending on the location in the loan cycle, an electronic signature, c-signature (e.g. a bio-signature), online signature, wet signature, or any other way to indicate acceptance of the BPP plan may be required.

If the borrower does not accept BPP, the method 600 may end at block 608 or continue to normal loan fulfillment processes (not shown). A waiver may be printed by the lender from the web site if the borrower is not going to accept the BPP plan.

If the borrower has accepted BPP, the method 600 continues to block 616. In block 616, in response to the borrower accepting BPP, an addendum and welcome letter is printed by the lender from the web site of the servicer to be included in the loan documentation for the borrower to include the BPP plan as a part of, an addendum to, or to be associated with a mortgage or other loan, whether it be an existing loan/mortgage or a loan/mortgage being accepted concurrently.

As illustrated in block 618, after setting up the mortgage or other loan product for the borrower, loan fulfillment is completed for the mortgage/loan product and/or the BPP accepted by the borrower. In one embodiment, the mortgage/loan product is fulfilled during the loan fulfillment process and the BPP is fulfilled and/or accepted thereafter. In another embodiment, the loan product and BPP plan are fulfilled at the same time. It yet another embodiment, only BPP can be fulfilled for an existing loan. It should be understood that the loan product and the BPP plan may be offered by the same financial institution or separate institutions. In one embodiment, the BPP plan is offered as an addendum to the loan product, as previously mentioned.

Continuing with block 618, after product fulfillment, the borrower is enrolled in the BPP plan. Enrollment in BPP activates the BPP plan so that foreclosure or other property loss may be prevented in the event that a covered event occurs.

In block 620, the mortgage/loan and BPP information (e.g., terms, conditions, obligations, and/or the like) is then loaded or logged into a servicing system of the servicer or other entity. The servicing system is maintained by the servicer, by another entity under contract with the servicer or by some other entity. Servicing may include collecting fees and mortgage payments, monitoring for covered events, paying benefits or claims in the event that one of the covered events associated with the BPP occurs, or other associated services. The servicing may also include accounting, auditing and other administrative and borrower services.

In block 620, the mortgage or other loan product and/or BPP is billed to the borrower via a servicing system of the servicer. The servicing system collects the monthly mortgage payments, including any principal and interest owed on the mortgage, as well as any required fees for the borrower's protection plan or other fees. Alternatively, the servicing system collects the monthly mortgage payments, including any principal and interest owed on the mortgage and the fee for the BPP plan can be taken from the principal and interest payments. In one embodiment, the servicer acts as a financial intermediary between an investor on the loan and/or a BPP entity and the borrower since the servicer collects payment(s)/fee(s) from the borrower (when a covered event has not occurred) and distributes portions of these payment(s)/fee(s) to the BPP entity and the investor (and/or other entities). Subject to the terms of the agreement of the borrower's protection plan, the borrower may be able to opt-out of the BPP without any fee or with a nominal opt-out fee.

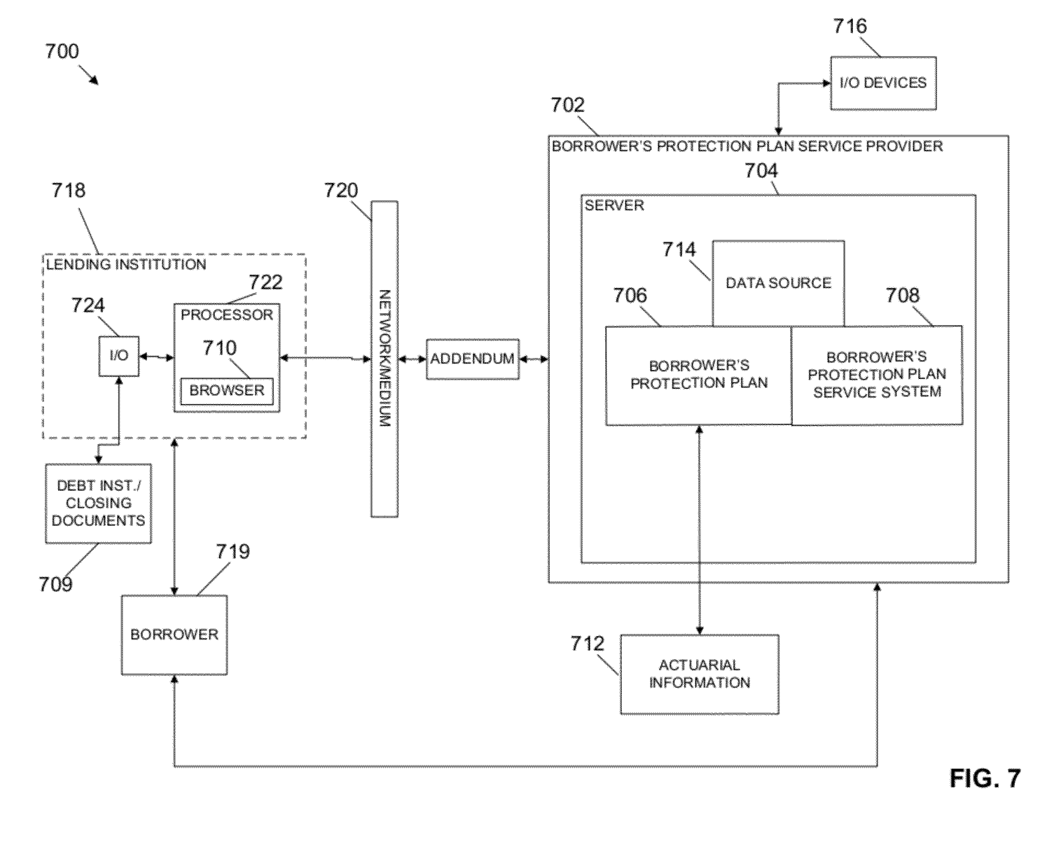

FIG. 7 is a block schematic diagram of an example of a system 700 for borrower's protection plan in accordance with another embodiment of the present invention. The system 700 includes a borrower's protection service provider 702. The borrower's protection service provider 702 includes a server 704. The server 704 is a web server or the like. A borrower's protection plan 706 and borrower's protection service system 708 operate or run on the server 704. The borrower's protection service system 708 is operable to service the borrower's protection plan (BPP) as described above. Elements or features of the methods FIGS. 5-6 are embodied in the borrower's protection plan 706 and service system 708. The borrower's protection plan 706 is operable on the server 704 to provide a borrower's protection plan (BPP) offerable with a loan as previously described herein. The borrower's protection plan 706 is adapted to create an addendum 707 for the borrower's protection plan (BPP) for inclusion in a debt instrument or closing documents 709 in response to an indication that a borrower wants to activate the BPP for free for a predetermined time period, similar to that described above with respect to methods of FIGS. 5-6. The borrower's protection plan 706 is also adapted or programmed to provide a quote for the BPP in response to selected information associated with a borrower and an associated loan. A financial institution representative enters the selected borrower and loan information into a web page or web form when the borrower's protection plan 706 is accessed via a web browser or the like, such as browser 710. The borrower's protection plan 706 is also programmed or adapted to present a web page or form for completion of an application for a BPP.

The system 700 also includes actuarial information 712 to establish pricing or quotes for the BPP in response to selected borrower and loan or mortgage information. A data source 714 is also included to log borrower's protection plan information and associated loan information. The information may be logged in response to the BPP application process and in response to closing the loan with an addendum for the BPP. The logged information is used in servicing the BPP.

The system 700 also includes input and output (I/O) devices 716. The I/O devices 716 are separate input and output devices or combination I/O devices that are coupled to the server 704 to provide an interface with the server 704 for programming purposes and to control operation of the server 704. Examples of the I/O devices 716 include a keyboard, pointing devices, display or monitor, disk drives, optical, mechanical, or infrared I/O devices or the like.

A lending institution 718, borrower 719 or other user accesses the borrower's protection plan 706 via a network 720, medium or the like, using a browser 710. The network or medium 720 is the Internet or a private network, such as an intranet or the like. The network or medium 720 is any communication network or system including by way of example, dedicated communication lines, telephone networks, and wireless data transmission systems, two-way cable systems, and customized computer networks, interactive kiosk networks or the like.

It should be understood that the borrower's protection plan service provider 702 may be part of the lending institution or may be run by a third party.

The browser 710 operates on a processor 722. Separate input and output devices 724 or combination I/O devices 716 are coupled to the processor 722 to permit a financial institution representative or other user to operate and interface with the processor 722. The I/O devices 724 are similar to the I/O devices 716. Examples of the I/O devices 724 include a keyboard, pointing device, display or monitor, disk drives, optical, mechanical, magnetic, or infrared input/output devices or the like. The I/O devices 724 are used to provide the addendum 709 for the BPP and the debt instrument of closing documents 709 including the addendum 707 for the BPP.

Borrower's Protection Plan as Using the Model for Predicting Unemployment Insurance Payment Dollars and Module for Predicting Unemployment Rate

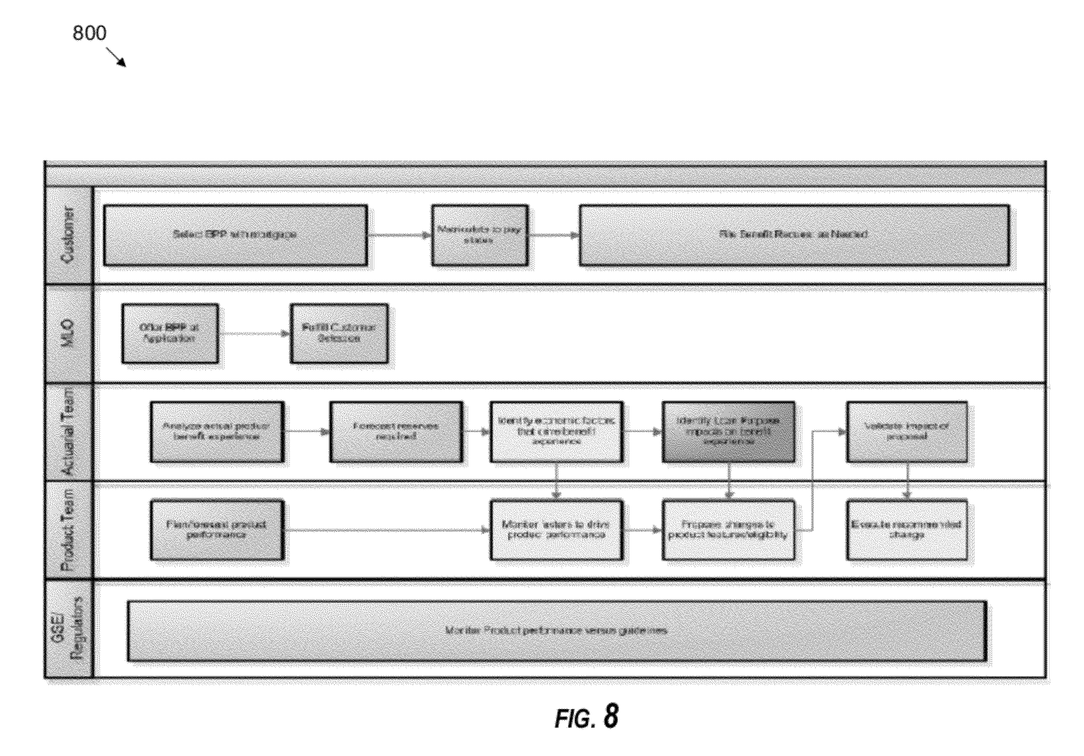

FIG. 8 is a flow chart illustrating a method 800 for implementing the BPP using the above-discussed predictive models and/or the predicted unemployment data. The method 800 is illustrated using swimlanes where each labeled entity performs the action in its respective swimlane. However, it should be understood that any entity can perform any of the actions in FIG. 8 and the actions should not be limited to be performed by the specified entity.

Regarding the lane labeled “MLO,” BPP is offered to a customer by a Mortgage Loan Originator (MLO) or other entity and if the customer selects BPP, the customer's selection is fulfilled.

The actuarial team analyzes actual product benefit experience, forecast reserves required, identifies economic factors that drive benefit experience and identifies loan purpose impacts on benefit experience.

The method 800 continues to the product team where, in response to identifying economic facts that drive the benefit experience, the product team monitors factors to drive product performance (such as the unemployment predicted data determined in FIGS. 1-4). Using such information as well as data related to the product team planning/forecasting product performance, the product team can propose changes to the product features. In response thereto, an impact of proposal is validated by the actuarial team and recommended changes are executed by the product team.

During the whole process, the government sponsored enterprise (GSE)/regulators monitor the whole method 800.

As shown in the swimlane labeled “Customer”, the customer wishes to include BPP with a loan, such as a mortgage. The customer selects BPP with the loan/mortgage and then when BPP matriculates to pay status. At this point, a benefits request may be filed as needed by the customer.

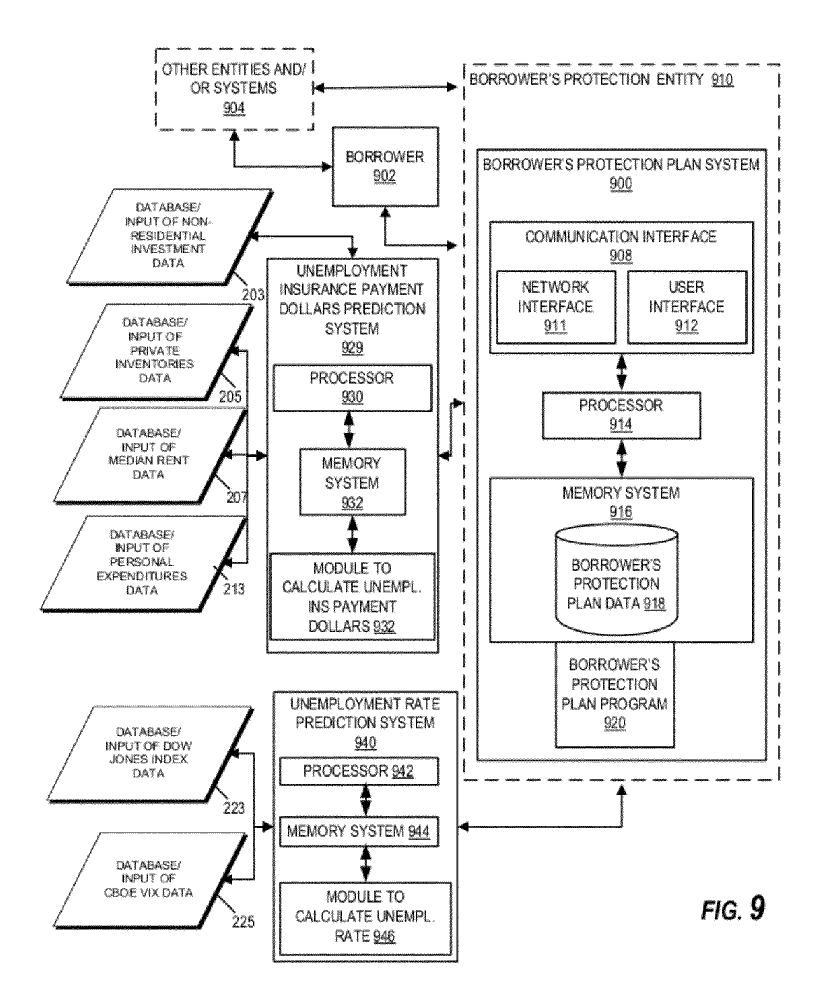

FIG. 9 is a high-level block schematic diagram of an example of a system 900 for a BPP plan in accordance with an embodiment of the present invention. The system 900 includes a communications interface 908, a BPP entity 910, a processor 914, a memory system 916, data 918 and a BPP program 920.

The communications interface 908 includes a network interface 911 and a user interface 912. The communications interface 908 can be used to interface with a web server, a computer at a bank for enrolling and/or managing the BPP plan, or the like. The BPP program 920 operates or runs on the processor 914 via the memory system 916 using the communications interface 908. The BPP program 920 includes computer-executable instructions accesses BPP plan data 918, such as terms and conditions, to allow the system 900 to service the BPP plan, as described above. These computer-executable instructions and BPP plan data 918 may be embodied in transitory or non-transitory computer-readable mediums, as is discussed in more detail later. The BPP system 900 can communicate with the borrower 902 either directly (e.g., via a representative at a financial institution) or through other entities and/or systems 904, such as a servicer and/or BPP entity.

FIG. 9 also illustrates the system related to the unemployment insurance payment prediction system 929 and unemployment rate prediction system 940. The unemployment insurance payment prediction system 929 includes a processor 930, a memory system 932 and a module to calculate unemployment insurance payment dollars 932, which performs the methods 200-201 of FIGS. 2A-2B. The module 932 is executed by processor 930 and is embodied in a non-transitory and/or transitory computer readable medium, which includes memory system 932.

The unemployment insurance payment prediction system 929 can communicate with databases 203, 205, 207 and 213 as was discussed above with regard to FIGS. 2A-2B. The unemployment rate prediction system 940 can communicate with databases 223 and 225 as was discussed previously with regard to FIG. 2C. Such communication allows the unemployment rate prediction system 940 and unemployment insurance payment prediction system 929 to query these databases and/or retrieve information therefrom.

Additionally, regarding in FIG. 9, the unemployment rate prediction system 940 includes a module for calculating the unemployment rate 946, which, when executed on processor 942, performs the method 220 of FIG. 2C. The module 946 is embodied in a non-transitory and/or transitory computer readable medium, which includes memory system 944.

Elements of embodiments of the present invention, such as methods of the present Figures are embodied in hardware and/or software as a computer program code that may include firmware, resident software, microcode or the like. Additionally, elements of the invention take the form of a computer program product on a computer-usable or computer-readable storage medium having computer-usable or computer-readable program code embodied in a medium for use by or in connection with a system. Examples of such a medium are illustrated in FIG. 7 as medium 720 or I/O devices 716 and 724 or the mediums in FIG. 9. A computer-usable or readable medium is any medium that contains, stores, communicates or transports the program for use by or in connection with a system. The medium, for example, is an electronic, magnetic, optical, electromagnetic, infrared or semiconductor system or the like.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving data of change in private inventories;
receiving data of percent change in non-residential investment;
receiving data of median rent; and
determining a total unemployment insurance payment dollars at a future predetermined date based on the change in private inventories data, the change in non-residential investment data, and the median rent data.

2. The method of claim 1, wherein a desired time period is selected and the change in private inventories, change in non-residential investment and median rent is obtained that occurred during the desired time period.

3. The method of claim 2, wherein the desired time period comprises data for a desired quarter, and wherein the future predetermined date comprises two quarters in the future relative to the desired quarter.

4. The method of claim 1, further comprising offering a user a loan, wherein a borrower's protection plan is offered to the user.

5. The method of claim 1, wherein the borrower's protection plan is offered based on the determined total unemployment insurance payment dollars.

6. The method of claim 4, wherein offering the borrower's protection plan comprises at least one of offering the borrower's protection plan through a lending institution extending the loan, and offering the borrower's protection plan through a borrower's protection service provider.

7. The method of claim 4, further comprising adding an addendum for the borrower's protection plan to a debt instrument in response to the user wanting to purchase the borrower's protection plan.

8. The method of claim 4, wherein the loan and the borrower's protection plan are both being offer by the same financial institutional.

9. The method of claim 1, wherein the determining a total unemployment insurance payment dollars comprises calculating the total unemployment insurance payment dollars using the following formula:
TOTAL NATIONAL UNEMPLOYMENT PAYMENT DOLLARS=−2,607,265.95+(−34,646,777.27X % CHANGE IN NON-RESIDENTIAL INVESTMENT)+(−24,516.205X CHANGE IN PRIVATE INVENTORIES)+(21,976.84X MEDIAN RENT).

10. A method comprising:
receiving data of percent change in personal consumption expenditures;
receiving data of change in private inventories;
receiving data of median rent; and
determining a total unemployment insurance payment dollars at a future predetermined date based on the change in personal consumption expenditures data, the change in private inventories data, and the median rent data.

11. The method of claim 10, wherein the future predetermined date comprises three quarters in the future.

12. The method of claim 10, wherein the change in personal consumption expenditures, change in private inventories and median rent are all determined at a desired date, and wherein the future predetermined date comprises three quarters in the future calculated from the desired date.

13. The method of claim 10, wherein the determining a total unemployment insurance payment dollars comprises calculating the total unemployment insurance payment dollars using the following formula:
TOTAL NATIONAL UNEMPLOYMENT PAYMENT DOLLARS=293,414.42+(−141,668,643.19X % CHANGE IN PERSONAL EXPENDITURES)+(19,427.36X MEDIAN RENT)+(−26,130.72X CHANGE PRIVATE INVENTORIES)

14. The method of claim 10, further comprising offering a user a loan and a borrower's protection plan with the loan.

15. A method comprising:
receiving data of change in private inventories;
receiving data of median rent; and
determining a total unemployment insurance payment dollars at a future predetermined date based on the change in private inventories data and the median rent data.

16. The method of claim 15, further comprising receiving data of percent change in non-residential investment, and
wherein the determining a total unemployment insurance payment dollars at a future predetermined date based on the change in private inventories data and the median rent data comprises:
determining a total unemployment insurance payment dollars at a future predetermined date based on the change in private inventories data, the percent change in non-residential investment data, and the median rent data.

17. The method of claim 15, further comprising receiving data of percent change in personal consumption expenditures,
wherein the determining a total unemployment insurance payment dollars at a future predetermined date based on the change in private inventories data and the median rent data comprises:
determining a total unemployment insurance payment dollars at a future predetermined date based on the percent change in personal consumption expenditures data, change in private inventories data, and the median rent data.

18. A method comprising:
receiving Dow Jones index data;
receiving Chicago Board Data Exchange Volatility Index (VIX) data; and
determining an unemployment rate at a future predetermined date based on the Dow Jones index data and the Chicago Board Data Exchange Volatility Index (VIX) data.

19. The method of claim 18, wherein the determining a unemployment rate comprises calculating the unemployment rate using the following formula:
UNEMPLOYMENT RATE=13.752+(−0.0007716X DOW JONES)+(0.07656X VIX)

20. The method of claim 18, further comprising using the predicted unemployment rate in evaluating products.

21. The method of claim 18, further comprising determining whether to offer a user borrower's protection plan based on the predicted unemployment rate in evaluating products.

22. A system, comprising:
a hardware processor;
a module operable on the hardware processor, the module configured for:
receiving data of change in change in private inventories;
receiving data of median rent; and
determining a total unemployment insurance payment dollars at a future predetermined date based on the change in change in private inventories data and the median rent data.

23. The system of claim 22, further comprising:
a borrower's protection program operable on the hardware processor to provide a borrower's protection plan for a predetermined time period and offerable in association with a loan.

24. The system of claim 22, wherein the module is further configured for receiving data of percent change in non-residential investment, and
wherein the determining a total unemployment insurance payment dollars at a future predetermined date based on the change in private inventories data and the median rent data comprises:
determining a total unemployment insurance payment dollars at a future predetermined date based on the change in change in private inventories data, the percent change in non-residential investment data, and the median rent data.

25. The system of claim 22, wherein the module is further configured for receiving data of percent change in personal consumption expenditures, and
wherein the determining a total unemployment insurance payment dollars at a future predetermined date based on the change in private inventories data and the median rent data comprises:
determining a total unemployment insurance payment dollars at a future predetermined date based on the percent change in personal consumption expenditures data, the change in private inventories, and the median rent data.

26. A computer-readable medium having computer-executable instructions therein for performing a method for protecting a borrower, the method comprising:
receiving data of change in private inventories;
receiving data of median rent; and
determining a total unemployment insurance payment dollars at a future predetermined date based on the change in private inventories data and the median rent data.

27. The computer-readable medium having computer executable instructions for performing the method of claim 26, further comprising receiving data of percent change in non-residential investment, and
wherein the determining a total unemployment insurance payment dollars at a future predetermined date based on the change in private inventories data and the median rent data comprises:
determining a total unemployment insurance payment dollars at a future predetermined date based on the change in change in private inventories data, the percent change in non-residential investment data, and the median rent data.

28. The computer-readable medium having computer executable instructions for performing the method of claim 26, further comprising receiving data of percent change in personal consumption expenditures,
wherein the determining a total unemployment insurance payment dollars at a future predetermined date based on the change in private inventories data and the median rent data comprises:
determining a total unemployment insurance payment dollars at a future predetermined date based on the percent change in personal consumption expenditures data, the data of change in private inventories, and the median rent data.

29. The computer-readable medium having computer executable instructions for performing the method of claim 26, further comprising determining whether to offer a borrower a borrower's protection plan based on the determining the total unemployment insurance payment dollars.

30. A system, comprising:
a hardware processor;
a module operable on the hardware processor, the module configured for:
receiving Dow Jones index data;
receiving Chicago Board Data Exchange Volatility Index (VIX) data; and
determining an unemployment rate at a future predetermined date based on the Dow Jones index data and the Chicago Board Data Exchange Volatility Index (VIX) data.

31. The system of claim 30, wherein determining a unemployment rate at a future predetermined date comprises calculating the unemployment rate by using the following formula;
UNEMPLOYMENT RATE=13.752+(−0.0007716X DOW JONES)+(0.07656X VIX).
